(19) United States
(12) Patent Application Publication
(10) Pub. No.: US 2011/0134430 A1
(43) Pub. Date: Jun. 9, 2011

(54) METHOD FOR DETERMINING THE GAS QUALITY OF SYNTHESIS GAS

(75) Inventor: Joachim Kastner, Dortmund (DE)

(73) Assignee: Elster GmbH, Dortmund (DE)

(21) Appl. No.: 12/737,772

(22) PCT Filed: Aug. 13, 2009
(86) PCT No.: PCT/DE2009/001170

§ 371 Date: Feb. 15, 2011

(30) Foreign Application Priority Data
Aug. 18, 2008 (DE) 10 2008 038 278.7

(51) Int. Cl. G01N 21/35

(52) U.S. Cl. 356/437

(57) ABSTRACT

The invention relates to a method for determining the gas quality of a sample gas having the main components H₂, CO, CO₂, N₂, CH₄, proceeding from a spectrum of the sample gas determined by means of infrared-spectroscopy measurement methods, from which the mole fractions of the sample gas are determined by means of correlative methods, and converted into characteristic variables of the gas quality. In this connection, the optical absorption of carbon monoxide CO, carbon dioxide CO₂, methane CH₄ and the heat conductivity λ of the sample gas are measured, the mole fraction xCO is determined from the absorption of the CO, the mole fraction xCO₂ is determined from the absorption of the CO₂, and the mole fraction xCH₄ is determined from the absorption of the CH₄, the optically not detected mole fractions of nitrogen xN₂ and of hydrogen xH₂ are determined from the mole fractions xCO, xCO₂ xCH₄ and the heat conductivity λ, by means of a correlation equation λ=F(xH₂,xCO,xCO₂,xN₂,xCH₄), whereupon characteristic parameters of the sample gas are calculated from the mole fractions obtained in this manner.

The invention relates to a method for determining the gas quality of synthesis gas, in accordance with the preamble of claim 1.

For the use of carbonaceous fuels for energy, it can be advantageous to utilize them not directly, thermally or in another manner, but rather to first convert them to so-called synthesis gas. In this connection, synthesis gas is understood to be all gas mixtures that contain hydrogen, which are intended for use in a synthesis reaction. Solid, liquid, and gaseous educts such as, for example, fossil fuels (for example coal), regenerative biomass, or waste products of the chemical industry are suitable for synthesis gas production. Synthesis gas production typically takes place by means of partial oxidation and steam reforming.

Utilization for energy by way of synthesis gas offers various advantages:
For one thing, the fuels can be purified well in the gas phase, in order to reduce or avoid possible harmful substances in the combustion waste gases. The removal of harmful substances from the waste gases would be significantly more complicated.
A further significant advantage is the possibility of efficient combustion of the gasified starting substances in a gas turbine. By means of an additional combination with a steam turbine for utilization of waste heat, a very good electrical overall degree of effectiveness of up to 60% can be achieved (Combined Cycle Power Plant CCPP, gas and steam power plant G&S).

The intermediate step by way of the synthesis gas is therefore advantageous in terms of environmental and energy technology. Against the background of the general debate about the environment and energy, traditional gasification technology is therefore regaining increasing importance.

The substance composition of synthesis gas determines its combustion-technology parameters. This composition is significantly dependent on the educts and the method parameters of gas production.

For efficient process control in synthesis gas production and utilization, rapid and precise analysis of the synthesis gas is desirable.

Synthesis gas typically consists of the following substance components:
Main components: H₂, CO,
Secondary components: CO₂, N₂, CH₄,
Further components such as, for example, H₂O, argon and other trace components having a typical concentration below 1%.

A possible technology for accomplishing this measurement task is gas chromatography. However, this measurement technology is discontinuous and relatively slow, and therefore it is only conditionally suitable for continuous and fast process control.

For individual components of synthesis gas, discrete continuous process measurement devices on the basis of IR-absorption (CO, CO₂, CH₄) exist; there are also commercial continuous process measurement devices for measuring heat conductivity. However, there is no method and no measurement system for a precise determination of synthesis gas in its totality and complexity, including the components H₂, N₂, which cannot be measured individually.

It is therefore the task of the present invention to carry out the process analysis of synthesis gas containing the decisive substance components H₂, CO, CO₂, N₂, CH₄, continuously, if at all possible.

The solution of the task according to the invention results from the characterizing characteristics of claim 1 in interaction with the characteristics of the preamble. Further advantageous embodiments of the invention are evident from the dependent claims.

The invention proceeds from a method for gas analysis of a sample gas having the main components H₂, CO, CO₂, N₂, CH₄, proceeding from a spectrum of the sample gas determined by means of infrared-spectroscopy measurement methods, from which spectrum the mole fractions of the sample gas are determined by means of correlative methods, and converted into characteristic variables of the gas quality. A method of this type is developed further in that the optical absorption of carbon monoxide CO, carbon dioxide CO₂, methane CH₄, and the heat conductivity λ of the sample gas are determined, the mole fraction xCO is determined from the absorption of the carbon monoxide, the mole fraction xCO₂ is determined from the absorption of the carbon dioxide, and the mole fraction xCH₄ is determined from the absorption of the methane, and subsequently, the optically not detected mole fractions of nitrogen xN₂ and of hydrogen xH₂ are determined from the mole fractions xCO, xCO₂ xCH₄ and the heat conductivity λ, by means of a correlation equation λ=F(xH₂,xCO,xCO₂,xN₂,xCH₄), whereupon characteristic parameters of the sample gas are calculated from the mole fractions obtained in this manner.

It is particularly advantageous, in this method of procedure, that the mole fractions of hydrogen H₂ and nitrogen N₂ can be determined directly, analytically, on the basis of the measurable values for the components carbon monoxide CO, carbon dioxide CO₂, methane CH₄ of the sample gas and the measurement of its heat conductivity λ, on the basis of the correlation calculation, by means of a simple linear statement. Alternatively, it is also possible that in the case of a non-linear statement, the correlation calculation is carried out until the value for the heat conductivity λ that proceeds from the correlation calculation corresponds to the measured value. Using the linear statement, it is therefore possible to determine the mole fractions of hydrogen H₂ and nitrogen N₂ in the sample gas, which were unknown until then, and from them, to analytically determine characteristic variables of the sample gas such as, for example, fuel value, heating value, density, Wobbe index, methane number, or the like. In this connection, the linear statement for the correlation of the gas components can be carried out in simple and therefore rapid manner, and only requires a manageable calculation effort. Only the values for the absorption of carbon monoxide CO, carbon dioxide CO₂, and methane CH₄, as well as the heat conductivity λ of the sample gas, are required as measurement values. In the case of alternative use of a non-linear statement, and, in this connection, a numerical solution that becomes necessary, starting values for the mole fractions of nitrogen xN₂ are required, on the basis of which a starting value for the mole fraction of the hydrogen H₂ can be calculated. Using these starting values and the measured values, it is then possible to carry out the correlation calculation in iterative manner, by means of adapting the values for mole fractions of nitrogen xN₂, and to adapt it by means of a comparison of the calculated heat conductivity λ and the measured heat conductivity λₘ, in each instance. If the values for calculated heat conductivity λ and measured heat conductivity λₘ agree, the actual mole fractions of nitrogen N₂ and hydrogen H₂ are present, and the further characteristic variables of the sample gas can be calculated from them, using physical laws.

It is advantageous for carrying out the method if a linear statement is selected from the mole fractions, for the correlation λ=F(xH₂,xCO,xCO₂,xN₂,xCH₄), for example as follows:

λ=λ₀+xH₂·λH₂+xCO·λCO+xCO₂·λCO₂+xN₂·λN₂+xCH₄·λCH₄

Such a statement can be carried out in simple manner, in terms of calculation technology, and analytically, and requires relatively little calculation effort. As a result, this statement can be carried out quickly during operation, and the results of the correlation, and thus the characteristic variables to be determined, are quickly available.

Alternatively, it is possible, for carrying out the method, that a statement with terms of a higher order and interaction terms is selected from the mole fractions for the correlation λ=F(xH₂,xCO,xCO₂,xN₂,xCH₄). It is true that such a non-linear statement is more complicated to calculate as compared with a linear statement, but greater precision of the results might possibly be obtained. Here, the solution of the statement of the correlation can take place by way of a polynomial statement, by means of numerical iteration.

It is advantageous for the linear statement as well as for the statement with terms of a higher order for the correlation calculation if the measured heat conductivity λₘ and the calculated heat conductivity λ are compared with one another by means of iterative variation and calculation of the unknown mole fractions for nitrogen xN₂ and hydrogen xH₂. In this connection, the essentially matching agreement of the measured heat conductivity λₘ and the calculated heat conductivity λ is the criterion on the basis of which the correlation calculation can be terminated. If agreement of the measured heat conductivity λₘ and the calculated heat conductivity λ exists, then the precise substance amount distribution of the components of the sample gas that cannot be determined by means of measurement technology can be calculated by means of back-calculation, using the statement of the correlation calculation, and from this, the characteristic variables can then be determined.

The method can also be developed further in that the heat conductivity of the sample gas is measured at two temperatures (λ1, λ2), and the mole fractions xH₂, xCO, xCO₂, xN₂, xCH₄ as well as a further unknown component xY are determined by means of solving a system of correlation equations

λ1=F1(xH₂,xCO,xCO₂,xN₂,xCH₄,xY)

λ2=F2(xH₂,xCO,xCO₂,xN₂,xCH₄, xY).

Examples of further gas components are argon Ar and water H₂O. In this connection, as well, the characteristic variables of the sample gas already described above can be calculated, after a determination of agreement of the calculated heat conductivities λ1, λ2 and the measured heat conductivities λ1ₘ, λ2ₘ.

A particularly preferred embodiment of the method according to the invention for the solution by means of numerical iteration when using a non-linear statement is shown in the drawing.

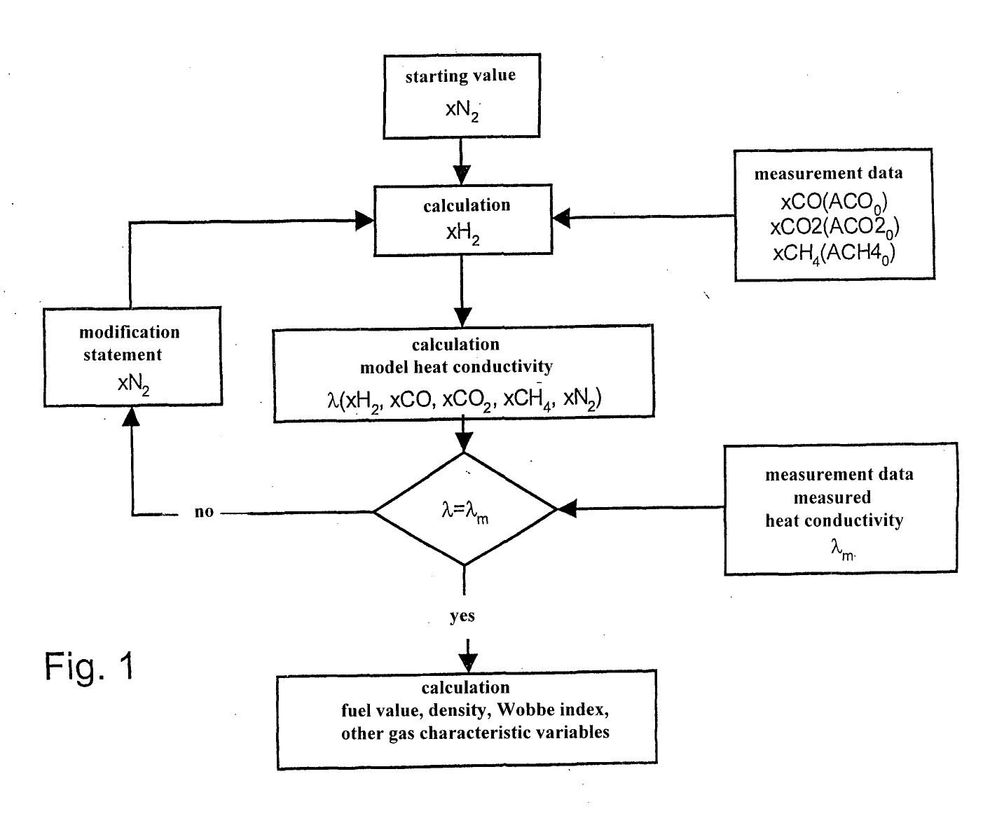

FIG. 1—Flow chart of the method for the correlation calculation and its implementation by means of numerical iteration when using a non-linear statement.

FIG. 1 describes the fundamental sequence of the method according to claim 1 for the correlation calculation and its implementation by means of numerical iteration when using a non-linear statement.

For this purpose, the following physical fundamentals must be formulated in advance for the correlation calculation as such:

For the measurement of the components of synthesis gas, the following statement can be used.

The following standardization applies:

xH₂+xCO+xCO₂+xN₂+xCH₄=1 Equ. 1

Fuel value and density are calculated as follows:

H=xH₂·HH₂+xCO·HCO+xCH₄·HCH₄ Equ. 2

ρ=xH₂·ρH₂+xCO·ρCO+xCO₂·ρCO₂+xN₂·ρN₂+xCH₄·ρCH₄ Equ. 3

The mole fractions xCO, xCO₂, and xCH₄ are determined directly from optical absorption measurements, according to the Beer-Lambert law. In this connection, it might be necessary to take special characteristic lines that deviate from the pure Beer-Lambert law into consideration (F1, F2, F3 are empirical calibration functions):

xCO=F1(ACO₀) Equ. 4

xCO₂=F2(ACO2₀) Equ. 5

xCH₄=F3(ACH4₀) Equ. 6

ACO₀, ACO2₀ and ACH4₀ are the optical absorptions with reference to a reference state (p₀, T₀). Suitable absorption bands lie in the infrared spectral range; typical ranges are: CO 4.4-5 μm, CO₂ 4.1-4.4 μm, CH₄ 3.1-3.6 μm.

The concentrations of H₂ and N₂ can be determined from the measurement of the heat conductivity λ, the standardization conditions from Equ. 1, and the following model calculation. For the heat conductivity of the gas, a linear mixed statement is established:

λ=xH₂·λH₂+xCO·λCO+xCO₂·λCO₂+xN₂·λN₂+xCH₄·λCH₄ Equ. 7

The standardization condition can be rearranged as follows:

xN₂=1−xH₂−xCO−xCO₂−xCH₄ Equ. 8

Inserting Equ. 8 into Equ. 7 and solving yields the mole fraction xH₂

$${x H}_{2} = \frac{\begin{matrix}λ - x CO \cdot ( λ CO - λ {N}_{2} ) - x {CO}_{2} \cdot ( λ {CO}_{2} - λ {N}_{2} ) - \\ x {CH}_{4} \cdot ( λ {CH}_{4} - λ {N}_{2} ) - λ {N}_{2}\end{matrix}}{λ {H}_{2} - λ {N}_{2}} \qquad Equ . 9$$

The concentration of the hydrogen xH₂ can therefore be determined from the measurement variables, and therefore the concentration xN₂ can also be calculated according to Equ. 8.

Thus, the mole fractions of all the gas components have been determined, and the target variables H, ρ can be calculated analytically.

In the case of alternative use of a non-linear statement and the numerical solution that becomes necessary in this connection, according to FIG. 1, starting values for the mole fractions of nitrogen xN₂ are required, on the basis of which a starting value for the mole fraction of the hydrogen H₂ can be calculated. Using these starting values and the measured values, the correlation calculation can then be carried out in iterative manner, by means of adaptation of the values for mole fractions of nitrogen xN₂, and adapted by means of a comparison of the calculated heat conductivity λ and the measured heat conductivity λₘ, in each instance. If the values for calculated heat conductivity λ and measured heat conductivity λₘ agree, the actual mole fractions of nitrogen N₂ and hydrogen H₂ are present, and the further characteristic variables of the sample gas can be calculated from them, using physical laws.

Statements for refinement and variation of the methods described can be implemented as follows, for example:
The statement for heat conductivity in Equ. 7 can be refined with terms of a higher order and with interaction terms. An analytical solution might then no longer be possible. The unknowns xH₂ and xN₂ can then be determined by means of numerical iteration.
Further information can be obtained by means of additional measurement of the heat conductivity at different temperatures. Possibly, the concentration of a further gas component, such as argon Ar and water H₂O, for example, can be determined in this manner.

1. Method for determining the gas quality of a sample gas having the main components H₂, CO, CO₂, N₂, CH₄, proceeding from a spectrum of the sample gas determined by means of infrared-spectroscopy measurement methods, from which spectrum the mole fractions of the sample gas are determined by means of correlative methods, and converted to characteristic variables of the gas quality,
wherein
the optical absorption of carbon monoxide CO, carbon dioxide CO₂, methane CH₄, and the heat conductivity λ of the sample gas are measured,
the mole fraction xCO is determined from the absorption of the CO, the mole fraction xCO₂ is determined from the absorption of the CO₂, and the mole fraction xCH₄ is determined from the absorption of the CH₄,
the optically not detected mole fractions of hydrogen xH₂ and of nitrogen xN₂ are determined from the mole fractions xCO, xCO₂ and xCH₄ and the heat conductivity λ, by means of a correlation equation λ=F(xH₂,xCO,xCO₂,xN₂,xCH₄),
whereupon characteristic parameters of the sample gas are calculated from the mole fractions obtained in this manner.

2. Method according to claim 1, wherein fuel value, heating value, density, Wobbe index, methane number or the like are determined as characteristic parameters of the sample gas.

3. Method according to claim 1, wherein a linear statement is selected from the mole fractions for the correlation λ=F(xH₂,xCO,xCO₂,xN₂,xCH₄):
λ=λ₀+xH₂·λH₂+xCO·λCO+xCO₂·λCO₂+xN₂·λN₂+xCH₄·λCH₄.

4. Method according to claim 1, wherein a statement having terms of a higher order and interaction terms is selected from the mole fractions for the correlation λ=F(xH₂,xCO,xCO₂,xN₂,xCH₄).

5. Method according to claim 4, wherein the solution of the statement of the correlation takes place by means of numerical iteration.

6. Method according to claim 1, wherein the measured heat conductivity λₘ and the calculated heat conductivity λ are compared with one another by means of iterative variation and calculation of the unknown mole fractions xN₂ and xH₂.

7. Method according to claim 6, wherein the mole fractions being sought are determined when equality of the measured heat conductivity λₘ and the calculated heat conductivity λ exists.

8. Method according to claim 1, wherein the heat conductivity of the sample gas is measured at two temperatures (λ1, λ2) and the mole fractions xH₂, xCO, xCO₂, xN₂, xCH₄ as well as of an unknown gas component xY are determined by means of solving a system of correlation equations
λ1=F1(xH₂,xCO,xCO₂,xN₂,xCH₄,xY)
λ2=F2(xH₂,xCO,xCO₂,xN₂,xCH₄,xY).
